(19) United States
(12) Patent Application Publication
(10) Pub. No.: US 2018/0219719 A1
(43) Pub. Date: Aug. 2, 2018

(54) INFORMATION PROCESSING METHOD AND SERVER

(71) Applicant: CANON KABUSHIKI KAISHA, Tokyo (JP)

(72) Inventors: Jun Hasegawa, Yokohama-shi (JP); Takashi Imoto, Nagareyama-shi (JP)

(21) Appl. No.: 15/852,568

(22) Filed: Dec. 22, 2017

(30) Foreign Application Priority Data
Jan. 31, 2017 (JP) 2017-015517

(51) Int. Cl. H04L 29/08; G06F 17/30

(52) U.S. Cl. CPC H04L 29/08; H04L 67/02; G06F 17/302

(57) ABSTRACT

An information processing method of the present invention includes: a transmission control step of performing transmission control of data to a server; a storage control step of storing backup data for data to be transmitted to the server; and an acquisition step of acquiring a retention period of data transmitted to the server. In the transmission control step, in a case where the transmission control was stopped and is started again and the acquired retention period continues, the stored backup data is transmitted so as to be continued from data that was transmitted to the server until the transmission control was stopped.

### BACKGROUND OF THE INVENTION

### Field of the Invention

The present invention relates to an information processing method and a server in an electronic commerce system.

### Description of the Related Art

In recent years, photo album creation services using an electronic commerce mechanism have been provided. A typical photo album creation service provides an application that runs on a personal computer (hereinafter “PC”) and a smart device (such as a smartphone or tablet). A user can operate the application installed on such an information processing apparatus to select images to be included in a photo album and edit a layout of each page, thereby generating photo album data necessary for photo album creation. A photo album manufacturer is supplied with the photo album data from the user via the Internet and prints the supplied photo album data to create an actual photo album.

Japanese Patent Laid-Open No. 2012-243107 discloses a method of dividing data to be uploaded into pieces and sequentially uploading the divided pieces of the data to a server. According to the method disclosed in Japanese Patent Laid-Open No. 2012-243107, even if an application was terminated in the midstream of a data upload, previously un-uploaded pieces of data can be uploaded to the restarted application so as to be continued from previously uploaded pieces of the data.

### SUMMARY OF THE INVENTION

The present invention aims at providing a technique to upload data appropriately based on a retention period of the data.

An information processing method of the present invention includes: a transmission control step of performing transmission control of data to a server; a storage control step of storing backup data for data to be transmitted to the server; and an acquisition step of acquiring a retention period of data transmitted to the server. In the transmission control step, in a case where the transmission control was stopped and is started again and the acquired retention period continues, the stored backup data is transmitted so as to be continued from data that was transmitted to the server until the transmission control was stopped.

Further features of the present invention will become apparent from the following description of exemplary embodiments with reference to the attached drawings.

### BRIEF DESCRIPTION OF THE DRAWINGS

FIG. 1 is a diagram showing an example of the configuration of a photo album creation support system in Embodiment 1;

FIG. 2 is a block diagram showing the hardware configuration of a PC in Embodiment 1;

FIG. 3 is a block diagram showing the software functional configuration of an application in Embodiment 1;

FIG. 4A to FIG. 4D are diagrams showing an example of display screens in Embodiment 1;

FIG. 5 is a flowchart showing the procedure of a photo album data upload in Embodiment 1;

FIG. 6 is a flowchart showing the procedure of a divided upload in Embodiment 1;

FIG. 7 is a flowchart showing another example of the procedure of the divided upload in Embodiment 1;

FIG. 8 is a flowchart showing another example of the procedure of the photo album data upload;

FIG. 9 is a flowchart showing a procedure at the termination of the application in Embodiment 1;

FIG. 10 is a flowchart showing a procedure at the start of the application in Embodiment 1; and

FIG. 11 is a flowchart showing the procedure of upload determination in Embodiment 1.

### DESCRIPTION OF THE EMBODIMENTS

In some servers, a retention period of uploaded photo album data is determined. For example, even if previously un-uploaded pieces of data are uploaded so as to be continued from previously uploaded pieces of the data as disclosed in Japanese Patent Laid-Open No. 2012-243107, the entire data cannot be reconstituted in some cases. More specifically, if a retention period of uploaded pieces of photo album data has elapsed, a server may delete the uploaded pieces of the data. In this case, the rest of the photo album data continued from the previously uploaded pieces of the data cannot be combined with the previously uploaded pieces of the data, with the result that the entire original photo album data cannot be reconstituted.

Embodiments of the present application will be described below in detail with reference to the accompanying drawings. It should be noted that the embodiments described below do not limit the scope of claims and not all combinations of features described in the embodiments are essential to techniques for solving the problem to be solved by the present invention. It should also be noted that the same constituent elements are represented by the same reference numerals.

### Embodiment 1

### (Configuration of Photo Album Creation Support System)

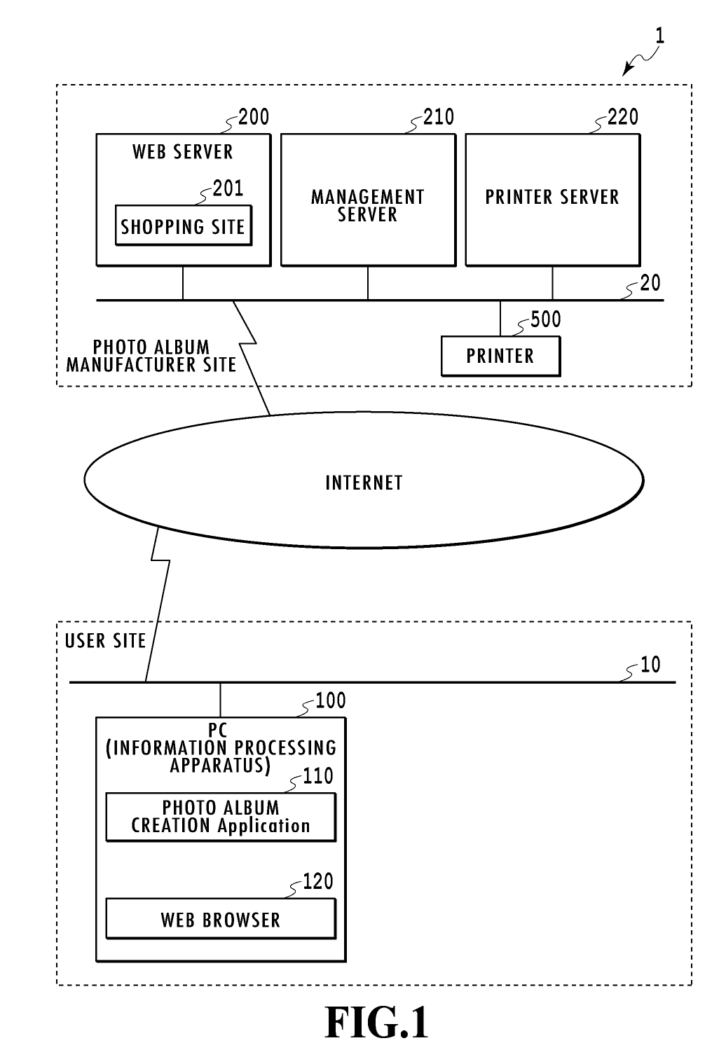

FIG. 1 is a diagram showing an example of the configuration of a photo album creation support system 1 in the present embodiment. The photo album creation support system 1 of the present embodiment includes a PC (information processing apparatus) 100, a web server 200, a management server 210, and a printer server 220, which are connected via a network so as to communicate with each other. It is assumed that an operating system (hereinafter “OS”) equivalent to Windows® 8 is installed on the PC 100 connected to the photo album creation support system 1. It is also assumed that an OS equivalent to Windows Server 2012 is installed on each of the servers connected to the photo album creation support system 1. The PC 100 is connected to a network (LAN) 10 configured by Ethernet™. The web server 200, the management server 210, and the printer server 220 are connected to a network (LAN) 20 configured by Ethernet. The network 10 and the network 20 are connected to each other via the Internet.

On the PC 100, a photo album creation application 110 (hereinafter also simply referred to as “application”) and a web browser 120 are installed. The application 110 runs on the PC 100 and mainly provides a user with (1) the function of selecting the specifications of a photo album, (2) the function of editing layouts, and (3) the function of ordering the photo album. The function (1) allows a user to select, on the PC 100, the specifications of a photo album such as a size, number of pages, type of paper, binding method, and cover material. The function (2) allows a user to edit a layout of each page of the photo album on the PC 100. The function (3) allows a user to place an order for the photo album created on the PC 100 with a photo album manufacturer. The web browser 120 is a browser (user agent) used when using the World Wide Web (WWW).

The web server 200 provides a website of a photo album manufacturer on the Internet. A shopping site 201 is operated by the photo album manufacturer and is capable of accepting an order for a photo album from a user.

When accepting an order for a photo album from the PC 100, the shopping site 201 transmits order information (such as a name, address, telephone number, and delivery address) about the accepted order to the management server 210. Further, the shopping site 201 receives status information and an invoice number (tracking number) regarding each order ID from the management server 210 and sends a delivery notice to an orderer based on them.

The management server 210 receives and temporarily stores photo album data uploaded from the PC 100 and manages the temporarily stored photo album data and the order information about the photo album transmitted from the web server 200 in association with an order ID. The management server 210 then transmits the photo album data and the order information to the printer server 220. The management server 210 also receives, from the printer server 220, the status information indicating a creation status of the photo album and the invoice number (tracking number) for checking a delivery status of the photo album, and uses them to update the order information managed by itself. Further, the management server transmits the status information and invoice number (tracking number) associated with the order ID to the web server 200 (shopping site 201). The photo album data will be described later in detail.

The printer server 220 receives the photo album data and order information transmitted from the management server 210. The printer server 220 uses lab system software (not shown) to convert the received photo album data into print data in a format printable by the printer 500. The printer server 220 transmits the print data to the printer 500 in response to a command input by an operator, thereby printing pages to be included in the photo album. The printed pages are bound into a photo album by using the finishing function of the printer 500 and then delivered based on the order information associated with the photo album. Binding and delivery of a photo album may be carried out in various ways, but description will be omitted because they are irrelevant to the main point of the present embodiment.

The printer 500 receives the print data transmitted from the printer server 220 and prints pages to be included in the photo album based on the received print data. For example, the print data includes a print ticket describing print settings and the like and a Portable Document Format (PDF) file.

The photo album creation support system 1 of the present embodiment has been described using an example in which the PC 100 on a user site places an order for a photo album with the web server 200 on a photo album manufacturer site. However, the present embodiment is not limited to this example. A hardware platform on which the photo album creation application 110 runs may be a portable information processing apparatus (smart device) such as a smartphone or tablet. In this case, the portable information processing apparatus can transmit photo album data and order information via a wireless communication network.

### (Hardware Configuration of Information Processing Apparatus)

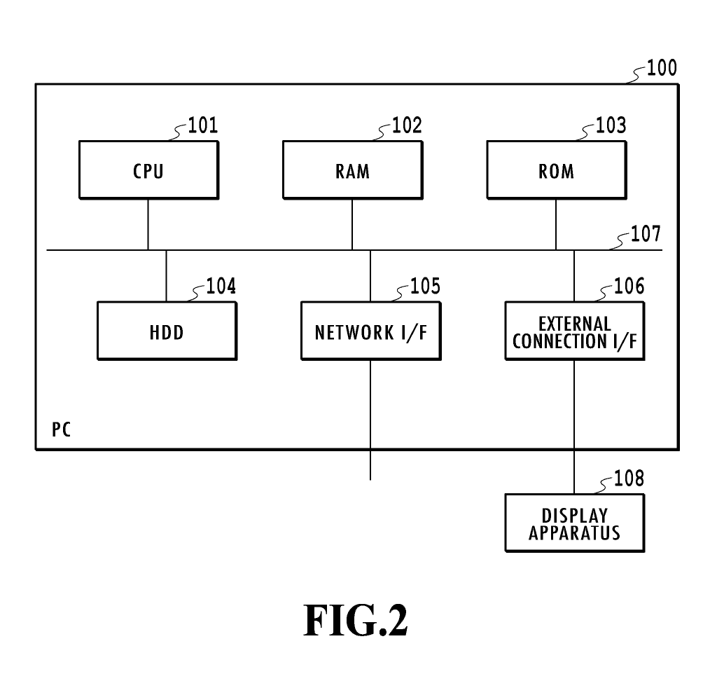

FIG. 2 is a block diagram showing the hardware configuration of the PC 100 in the present embodiment. The hardware configuration of the PC 100 in the present embodiment is in conformance with the hardware configuration of a general information processing apparatus. The web server 200, the management server 210, and the printer server 220 can also be implemented by the same hardware configuration. The PC 100 includes a CPU 101, a RAM 102, a ROM 103, a hard disk drive (HDD) 104, a network interface (interface will be hereinafter referred to as “I/F”) 105, and an external connection I/F 106. These constituent elements are connected via a bus 107 so as to communicate with each other. The CPU 101 includes an arithmetic circuit and exercises control over the PC 100. The CPU 101 loads system programs and application programs stored in the ROM 103 or HDD 104 into the RAM 102 to execute various processes. The ROM 103 stores, for example, system programs used to control the PC 100. The HDD 104 serves as a nonvolatile storage area and may be a solid state drive (SSD), a portable CD-ROM or the like instead of an HDD. The network I/F 105 controls data input to and data output from the web server 200 and the like under the control of the CPU 101. The external connection I/F 106 is an interface for connecting various devices to the PC 100. In the present embodiment, a display apparatus (display unit) 108 is connected. The display apparatus 108 may be, for example, a liquid crystal display (LCD). Besides the display apparatus 108, various input and output devices such as a keyboard and mouse can be connected to the PC 100 via the external connection I/F 106.

### (Functional Configuration of Photo Album Creation Application)

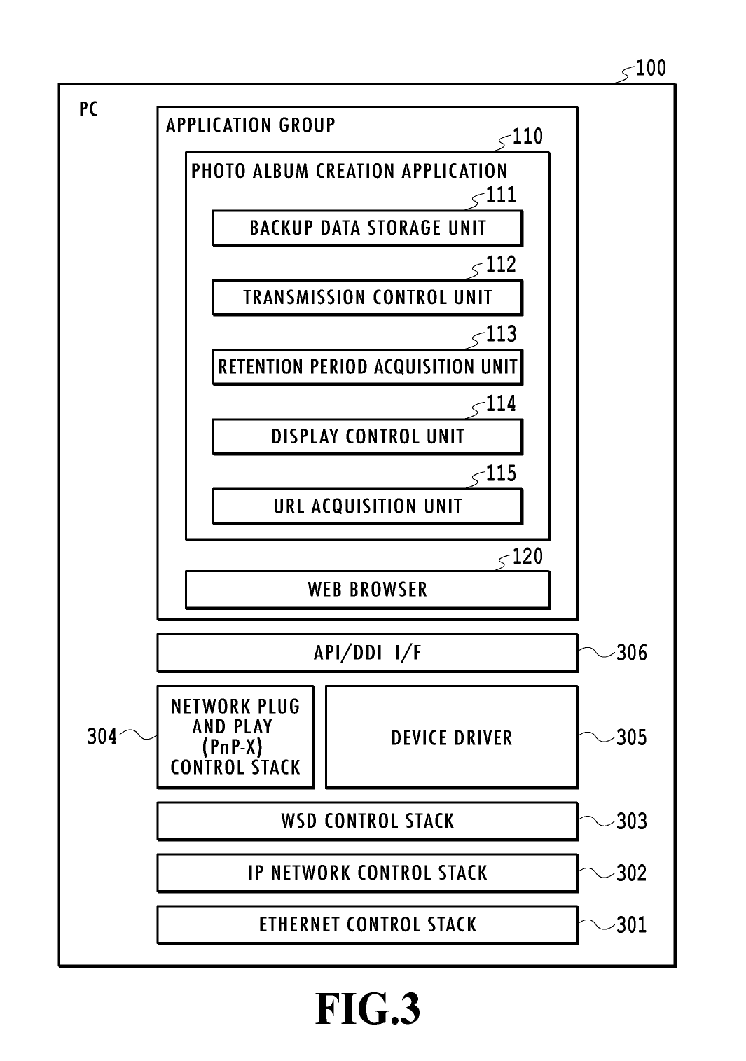

FIG. 3 is a block diagram mainly showing the software functional configuration of the application 110 in the present embodiment. The functional blocks shown in FIG. 3 are implemented by the CPU 101 loading program code stored in the ROM 103 or HDD 104 into the RAM 102 and executing it.

In FIG. 3, an Ethernet control stack 301 executes communication control in conformance with the Ethernet standard. An IP Network control stack 302 executes communication control in conformance with the TCP/IP standard. A WSD control stack 303 controls Web Service on Devices (WSD) providing a mechanism to search for devices on a network. A PnP-X control stack 304 controls Plug and Play of a network connection device. PnP-X is the abbreviation for “Plug and Play Extensions,” a standard feature of Windows 8 OS. A device driver 305 is used to control the operation of devices of the PC 100 and includes a standard driver group included in the OS as standard and an IHV driver group supplied by a manufacturer of a device. An API/DDI I/F 306 includes an application programming interface (API) and a device driver interface (DDI).

As described above, the photo album creation application 110 and the web browser 120 are installed on the PC 100. The photo album creation application 110 has functional blocks for implementing the functions of the photo album creation application 110. A backup data storage unit 111 stores, in the HDD 104, backup data for photo album data to be uploaded. A transmission control unit 112 controls transmission of photo album data to each of the servers (such as the web server 200 and the management server 210) on the photo album manufacturer site. A retention period acquisition unit 113 acquires a retention period of photo album data uploaded to the management server 210. A display control unit 114 controls screen display on the display apparatus 108. A URL acquisition unit 115 acquires, from the web server 200, a URL necessary for allowing the web browser 120 to display given information. The web browser 120 is a browser (user agent) used when using the World Wide Web (WWW).

### (Display Screens of Photo Album Creation Application)

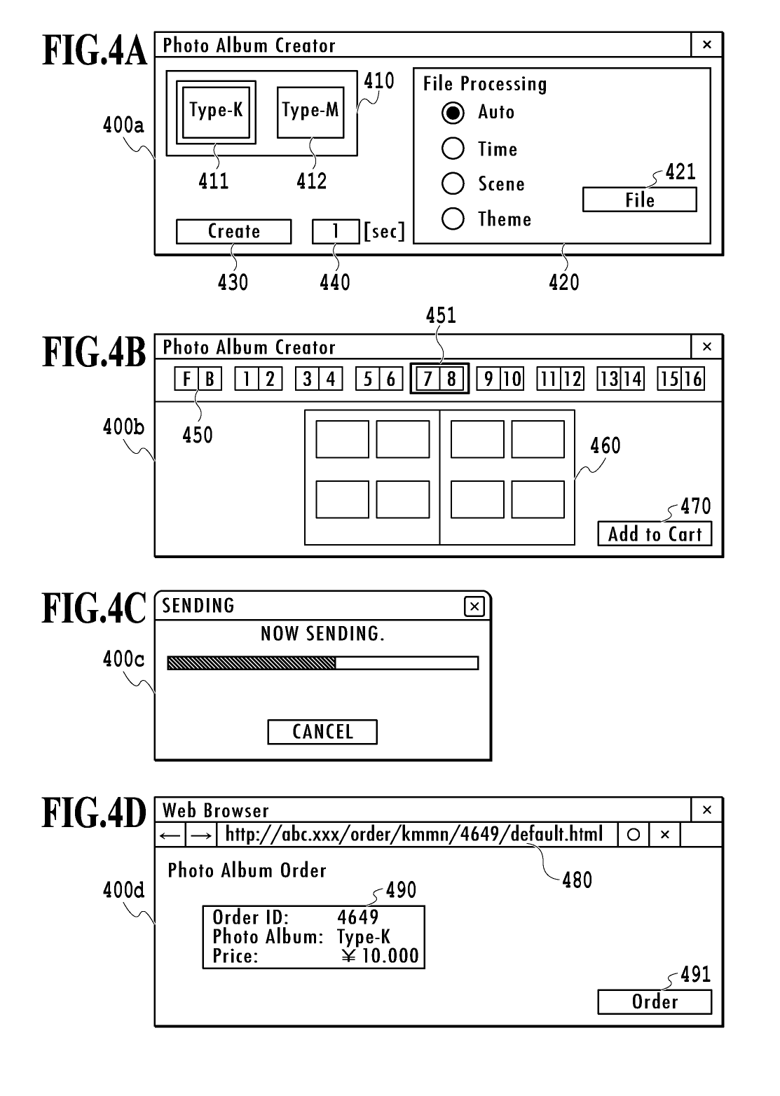

FIG. 4A to FIG. 4D are diagrams showing an example of display screens displayed on the display apparatus 108 in the present embodiment. A display screen 400a shown in FIG. 4A is an example of a main screen. A display screen 400b shown in FIG. 4B is an example of a preview screen. A display screen 400c shown in FIG. 4C is a pop-up window displayed at least in part of a sending screen. A display screen 400d shown in FIG. 4D is an example of a screen for ordering a photo album (hereinafter simply referred to as “order screen”) displayed on the web browser 120. The display screens will be described below with reference to FIG. 4A to FIG. 4D.

The display screen 400a (main screen) shown in FIG. 4A includes a type selection area 410, a file processing method selection area 420, a photo album creation button 430, and a time interval designation area 440. The type selection area 410 is a user interface (hereinafter “UI”) capable of accepting selection of a photo album type. In the present embodiment, the type selection area 410 accepts selection of a user-desired photo album type from type K, type M, type N, type S, type T, and type U. In the present embodiment, the specifications of a photo album such as a size, number of pages, type of paper, binding method, and cover material are determined for each photo album type. For example, for “type K” highlighted in a selection display area 411 in the display screen 400a of FIG. 4A, the specifications are set as described below.

Size: 15 cm×15 cm

Number of Pages: 20

Type of Paper: Satin

Binding Method: Half Fold

Cover: Soft

The specifications are selectively set for each type, for example, the type of paper may be “Glossy” and the cover may be “Hard,” but description will be omitted for details about the specifications. Although only “type K” and “type M” are displayed in the type selection area 410 in FIG. 4A, the selection of other types can be accepted by scrolling the type selection area 410.

The file processing method selection area 420 is a UI used to select images included in a photo album to be created. The application 110 of the present embodiment can automatically extract images to be included in a photo album from a video file stored in the PC 10 as well as selecting from image data (still image) stored in the PC 100. The file processing method selection area 420 has radio buttons capable of accepting selection from “Auto,” “Time,” “Scene,” and “Theme.” The application 110 extracts images in accordance with a selected extraction course. For example, if “Time” is selected, the application 110 extracts related frames from a video file as images to be included in a photo album based on time information at the time of the video shoot (time, month, day, and year). If “Scene” is selected, the application 110 extracts related frames from a video file as images to be included in a photo album based on the colors and histogram of each frame. If “Theme” is selected, the application 110 extracts related frames from a video file as images to be included in a photo album based on a similarity of objects between frames. The file processing method selection area 420 further has a file selection button 421. When the press of the button is detected, a file selection window (not shown) is displayed to accept selection of a video file from which images are to be extracted and to accept selection of image data (still image) to be included in a photo album.

The time interval designation area 440 can accept the setting of a time interval between frames to be selected in the case of extracting images from a video file. In the present embodiment, the time interval between frames can be set in seconds. As a default value, “1 second” is input to the time interval designation area 440 in advance.

When the press of the photo album creation button 430 is detected, the application 110 starts generating photo album data necessary for creating a photo album based on the accepted photo album type and the extracted or selected images. The photo album data is a data set necessary for printing an actual photo album and includes at least image data on images included in a photo album, data specifying layouts, and data indicating the specifications of the photo album.

The display screen 400b (preview screen) shown in FIG. 4B includes a double-page spread selection area 450, a preview display section 460, and an add-to-cart button 470. The preview display section 460 displays a preview of a double-page spread of a photo album based on photo album data generated by the application 110. The double-page spread selection area 450 can accept selection of a double-page spread to be displayed in the preview display section 460. In the example of FIG. 4B, a double-page spread of pages 7 and 8 selected in the double-page spread selection area 450 is highlighted in a selection display area 451 and the enlarged image of this double-page spread is displayed in the preview display section 460. Further, the application 110 can edit the preview display section 460 in accordance with user operation input via an input device (not shown) such as a mouse or keyboard connected to the external connection I/F. More specifically, the application 110 can execute layout editing to edit the positions of images displayed in the preview display section 460 and text editing such as addition of user-desired text.

The add-to-cart button 470 is a UI for adding a product that a user wants to purchase to a shopping cart like a general online shopping site. When the press of the add-to-cart button 470 is detected, the application 110 adds a creation service of a photo album displayed in the preview display section 460 to the shopping cart as a product to be purchased.

The display screen 400c shown in FIG. 4C is a pop-up window displayed at least in part of the sending screen when the press of the add-to-cart button 470 in FIG. 4B is detected and an upload of the photo album data is started. That is, the application 110 of the present embodiment starts uploading the photo album data upon the addition of the photo album creation service to the shopping cart as a product to be purchased.

A user can select a “x” button in the display screen 400c by operating a mouse or the like to stop uploading the photo album data and terminate the operation of the application 110.

Next, the screen is transitioned to the display screen (order screen) 400d shown in FIG. 4D. In the present embodiment, when ordering a photo album, given operation (for example, input of a credit card number) is required in a banking site cooperating with the order screen of FIG. 4D in addition to the operation in the order screen. It should be noted that description will be omitted for a display screen indicating a state where a product to be purchased is added to the shopping cart, a display screen indicating a state where information necessary for banking is input in the banking site and the like, which are general techniques in the field of electronic commerce.

The display screen 400d (order screen) shown in FIG. 4D has a URL display section 480, an order information display section 490, and an order button 491. The URL display section 480 accepts designation of a Uniform Resource Locator (URL) of a website to be displayed by the web browser 120 and also shows a URL of a website currently displayed by the web browser 120. The order information display section 490 is an area to display order information about a photo album. In the present embodiment, order information about the photo album edited in FIG. 4B is displayed in the order information display section 490 in association with an order ID. In the example of the order screen of FIG. 4D, “Type-K” (photo album type) and “Y10,000” (price) are displayed in association with “Order ID: 4649.” When the press of the order button 491 is detected, an order for the photo album is finally confirmed on the condition that delivery information such as a name, address, telephone number, and delivery address is input in a post-transition screen (not shown) displayed subsequent to the display screen 400d.

A user can select a “x” button in the display screen 400d by operating a mouse or the like to terminate the operation of the application 110 without confirming an order after an upload of photo album data is completed.

### (Procedure of Photo Album Creation Application)

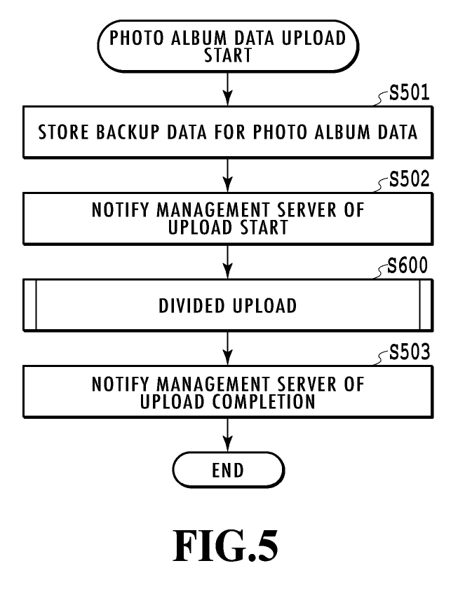

FIG. 5 is a flowchart showing the procedure of a photo album data upload from the application 110 to the management server 210 in the present embodiment. The process of the flowchart shown in FIG. 5 is performed by the CPU 101 expanding program code, stored in the HDD 104, in the RAM 102 and executing it. In the description below, sign S represents a step in the flowchart. The same applies to the flowcharts following FIG. 5.

In S501, the backup data storage unit 111 stores, in the HDD 104, backup data for photo album data to be uploaded.

In S502, the transmission control unit 112 notifies the management server 210 of the start of an upload of the photo album data.

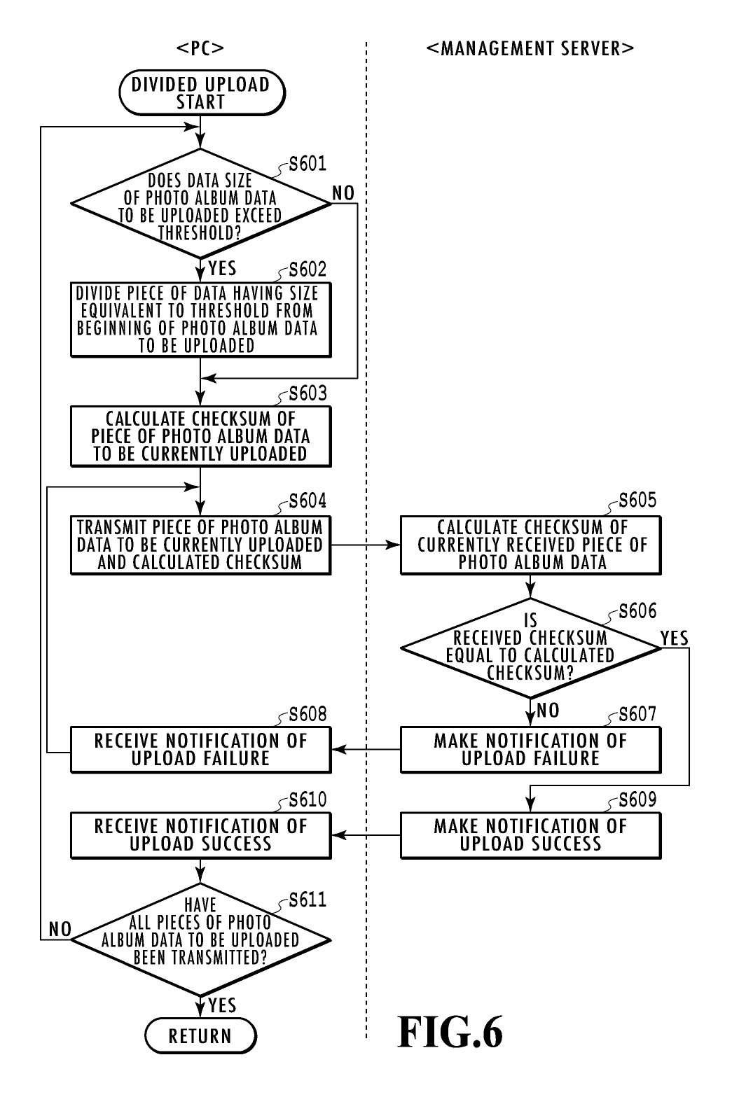

In S600, the transmission control unit 112 executes a divided upload for dividing the photo album data into pieces and transmitting them to the management server 210. The procedure of the divided upload will be described in detail with reference to FIG. 6.

In S503, the transmission control unit 112 notifies the management server 210 of the completion of the upload of the photo album data. After the notification is provided to the management server 210, the process of the flowchart is ended.

FIG. 6 is a flowchart showing the procedure of the divided upload (S600) of the photo album data executed by the transmission control unit 112 in the present embodiment. The process of the flowchart corresponds to S600 in FIG. 5.

In S601, the transmission control unit 112 determines whether the data size of the photo album data to be uploaded exceeds a threshold. The threshold is a value set according to the performance of the PC 100 and management server 210 and may be a fixed value or a value variable according to the operating environments of the PC 100 and management server 210. If the data size exceeds the threshold (YES in S601), the process proceeds to S602. In this case, the photo album data to be uploaded is transmitted by a plurality of transmission processes. If the data size is equal to or less than the threshold (NO in S601), the process skips S602 and proceeds to S603. In this case, the photo album data to be uploaded is transmitted at a time.

In S602, the transmission control unit 112 divides a piece of the photo album data having a data size equivalent to the threshold from the beginning of the photo album data to be uploaded.

In S603, the transmission control unit 112 calculates a checksum of the piece of the photo album data to be currently uploaded.

In S604, the transmission control unit 112 transmits, to the management server 210, the piece of the photo album data to be currently uploaded and the checksum calculated in S603.

In S605, the management server 210 calculates a checksum of the piece of the photo album data received from the PC 100.

In S606, the management server 210 determines whether the checksum received from the PC 100 and the checksum calculated in S605 are equal to each other. If the checksums are different from each other (NO in S606), the process proceeds to S607, where the management server 210 abandons the received piece of the photo album data and notifies the PC 100 that the photo album data upload has failed. After the PC 100 is notified of the failure of the photo album data upload in S608, the process returns to S604 to retransmit the piece of the photo album data and calculated checksum transmitted in S604 to the management server.

In the present embodiment, S604 to S608 are repeated until the photo album data is successfully uploaded. However, the repeat of the process may be stopped to terminate the divided upload if a given number of retries is exceeded. In this case, the given number of retries may be always a fixed value or may be a value variable according to the operating environments of the PC 100 and management server 210. Further, a period during which the photo album data upload can be retried may be set besides the number of retries.

If the checksums are equal to each other (YES in S606), the process proceeds to S609, where the management server 210 notifies the PC 100 that the photo album data upload has succeeded. After the PC 100 is notified of the success of the photo album data upload in S610, the PC 100 proceeds to a determination process of S611.

In S611, the transmission control unit 112 determines whether all pieces of the photo album data to be uploaded have been transmitted. If all the pieces of the photo album data have been transmitted (YES in S611), the process of this subroutine is ended and the process returns to the flowchart of FIG. 5.

On the other hand, if not all the pieces of the photo album data have been transmitted (NO in S611), the process returns to S601 to repeat S601 to S611. In short, a divided piece of the photo album data to be uploaded is transmitted to the management server 210 each time S601 to S611 are repeated.

In the divided upload of the present embodiment, the management server 210 compares a checksum received from the PC 100 with a checksum calculated from a piece of photo album data received from the PC 100 to make a determination. In other embodiments, the PC 100 may compare the checksums to make a determination. In this case, the CPU 101 (transmission control unit 112) stores a checksum calculated by itself in a given storage area, receives a checksum of a piece of photo album data calculated in the management server 210, and then compares the stored checksum with the received checksum to make a determination. If the checksums are different from each other, the CPU 101 notifies the management server 210 that the transmission of the piece of the photo album data to be currently uploaded has failed. After the management server 210 is notified of the failure of the photo album data upload, the management server 210 abandons the received piece of the photo album data.

In the divided upload of the present embodiment, the management server 210 calculates a checksum from a piece of photo album data received in S605. Since the address of a web server is generally on public view, it is not preferable in view of security to store a received piece of photo album data in a storage area accessible via the web server 200. Therefore, the management server 210 may store a received piece of photo album data in a storage area not accessible from an external network and calculate a checksum from the stored piece of the photo album data. Further, as well as comparing checksums of a divided piece of photo album data, the management server 210 may compare a checksum calculated from photo album data before being divided with a checksum calculated from photo album data after being combined for the purpose of protection against tampering.

In the divided upload of the present embodiment, the management server 210 compares checksums each time a divided piece of photo album data is received. However, the management server 210 may compare checksums at once after the photo album data is completely received.

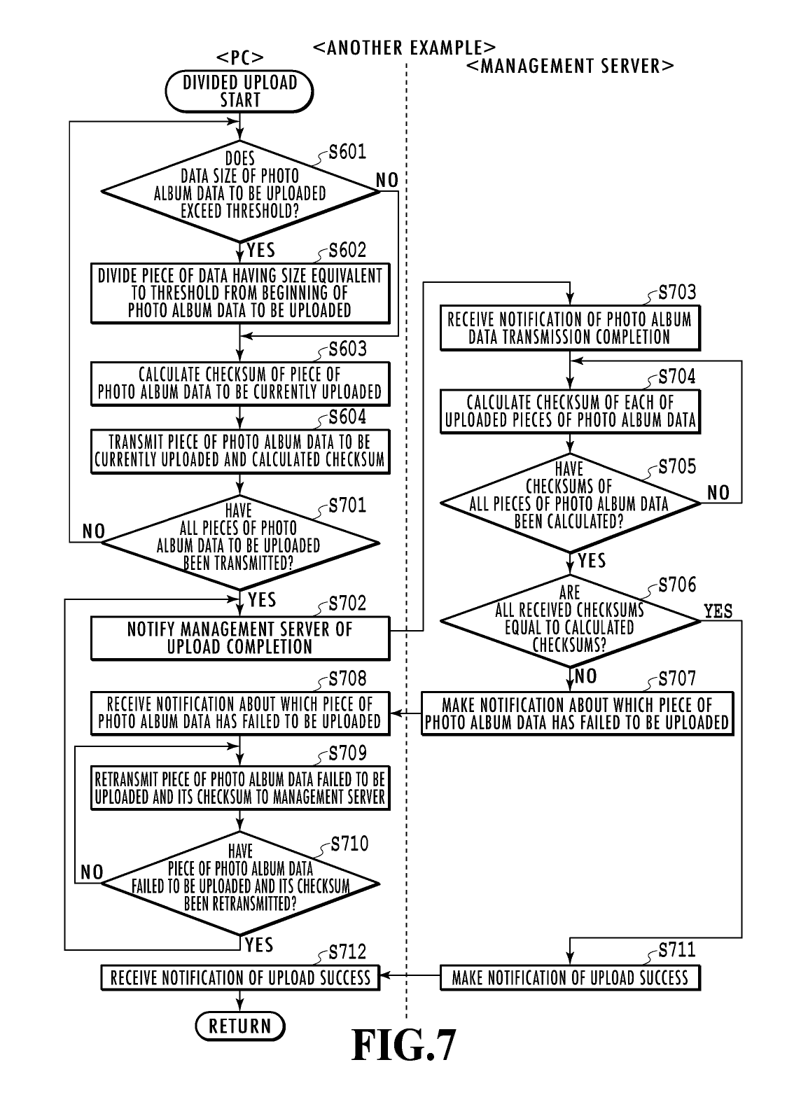

FIG. 7 is a flowchart showing another example of the procedure of the divided upload (S600) of the photo album data executed by the transmission control unit 112 in the present embodiment. The process of this flowchart corresponds to S600 in FIG. 5. In the following description of the flowchart of FIG. 7, the same steps as those of the flowchart of FIG. 6 will be represented by the same reference numerals and overlapping description will be omitted. S601 to S604 are the same as those of the flowchart of FIG. 6 and therefore description is omitted.

In S701, the transmission control unit 112 determines whether all pieces of photo album data to be uploaded have been transmitted. If all the pieces of the photo album data have been transmitted (YES in S701), the process proceeds to S702. If not all the pieces of the photo album data have been transmitted (NO in S701), the process returns to S601 to repeat S601 to S701.

In S702, the transmission control unit 112 notifies the management server 210 that all the pieces of the photo album data to be uploaded have been transmitted.

After the management server 210 receives the notification that all the pieces of the photo album data to be uploaded have been transmitted from the PC 100 in S703, the process proceeds to S704.

In S704, the management server 210 calculates a checksum from each piece of the photo album data received from the PC 100 and stores the calculated checksums in a given storage area.

In S705, the management server 210 determines whether checksums of all pieces of the photo album data received from the PC 100 have been calculated. If all the checksums have been calculated (YES in S705), the process proceeds to a determination process of S706. If not all the checksums have been calculated (NO in S705), the process returns to S704. In short, S704 and S705 are repeated until checksums of all pieces of photo album data received from the PC 100 are calculated.

In S706, the management server 210 determines whether all the checksums transmitted from the PC 100 are equal to the checksums calculated in S704. As a result of a comparison between the checksums transmitted from the PC 100 with the checksums calculated in S704, if a checksum of any piece of the photo album data is different from a corresponding checksum transmitted from the PC 100 (NO in S706), the process proceeds to S707.

In S707, the management server 210 abandons the piece of the received photo album data that has failed to be uploaded and notifies the PC 100 which piece of the photo album data has failed to be uploaded.

In S708, the PC 100 receives, from the management server 210, the notification about which piece of the photo album data transmitted in S604 has failed to be uploaded.

In S709, the transmission control unit 112 retransmits the piece of the photo album data that has failed to be uploaded and its checksum to the management server 210.

In S710, the transmission control unit 112 determines whether the piece of the photo album data and its checksum have been retransmitted. If the piece of the photo album data and its checksum have been retransmitted (YES in S710), the process returns to S702. If the piece of the photo album data and its checksum have not been retransmitted (NO in S710), the process returns to S709.

In the present embodiment, S702 to S710 are repeated until all pieces of photo album data are successfully uploaded. However, the repeat of the process may be stopped to terminate the divided upload process if a given number of retries is exceeded. In this case, the given number of retries may be always a fixed value or may be a value variable according to the operating environments of the PC 100 and management server 210.

As a result of a comparison between the checksums transmitted from the PC 100 and the checksums calculated in S704, if they are all equal to each other (YES in S706), the process proceeds to S711.

In S711, the management server 210 notifies the PC 100 that the photo album data upload has succeeded.

After the PC 100 is notified of the success of the photo album data upload in S712, the PC 100 terminates the process of this subroutine and returns to the flowchart shown in FIG. 5.

In this example too, the PC 100 may compare checksums to make a determination in place of the management server 210. In addition, although the management server 210 starts calculating checksums after receiving all pieces of photo album data in the divided upload of this example, the procedure is not limited to this. The management server 210 may calculate checksums without synchronization with receiving photo album data from the PC 100. To be more specific, the management server 210 may calculate a checksum each time a divided piece of photo album data is transmitted, or may check whether a divided piece of photo album data is transmitted and if it is transmitted, calculate a checksum as appropriate.

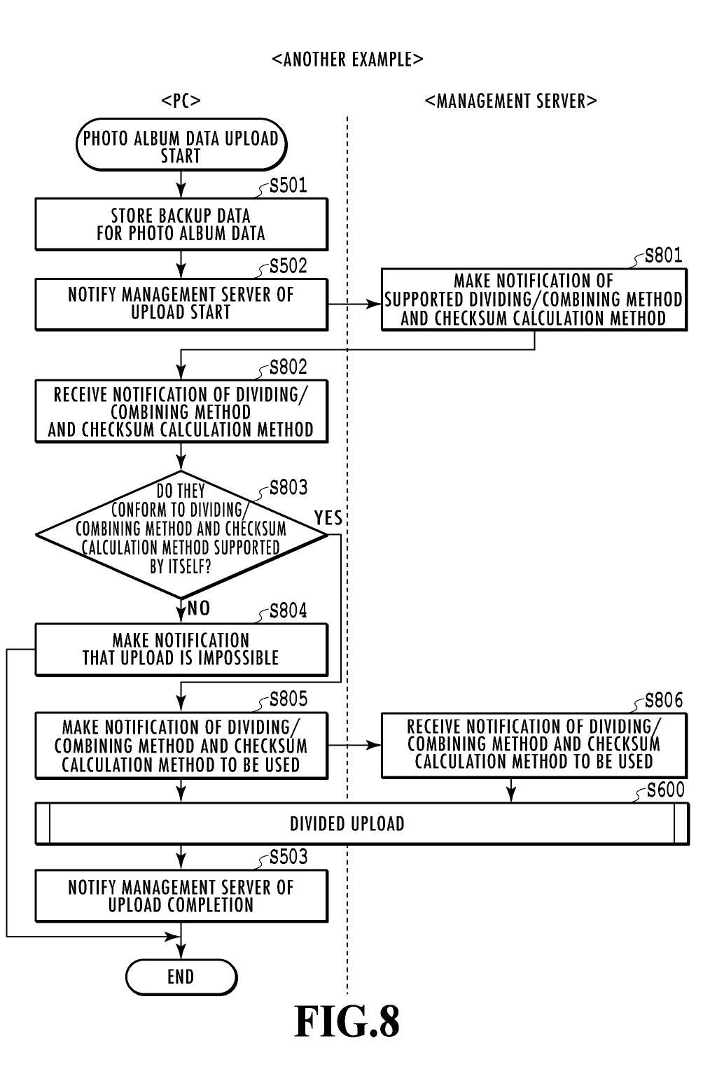

The divided upload of photo album data has been described with reference to FIG. 5 to FIG. 7. However, if there is a difference in a method of dividing and combining photo album data between the PC 100 and the management server 210, the correctness of exchanged photo album data cannot be ensured. This difference may occur depending on a combination of a version of the application 110 that runs on the PC 100 and a version of an application that runs on the management server 210. In another example shown in FIG. 8, description will be provided for the procedure of a divided upload of photo album data in consideration of supported dividing/combining methods and checksum calculation methods between the PC 100 and the management server 210.

FIG. 8 is a flowchart showing another example of the procedure of a photo album data upload. In the following description of the flowchart of FIG. 8, the same steps as those of the flowchart of FIG. 5 will be represented by the same reference numerals and overlapping description will be omitted.

S501 and S502 are the same as those of the flowchart of FIG. 5 and therefore description is omitted.

In S801, the management server 210 notifies the PC 100 of a dividing/combining method and checksum calculation method supported by the management server 210.

In S802, the transmission control unit 112 receives the dividing/combining method and checksum calculation method supported by the management server 210 from the management server 210.

In S803, the transmission control unit 112 determines whether the dividing/combining method and checksum calculation method supported by the management server 210 conform to those supported by itself. If they do not conform to each other (NO in S803), the process proceeds to S804, where the transmission control unit 112 notifies a user that photo album data cannot be uploaded. After the notification is provided to the user, the process of this flowchart is ended. A message is displayed on the display apparatus 108 to notify the user that photo album data cannot be uploaded. At this time, it is also possible to make a notification that prompts a user to update the application 110 to a new version and a notification that guides a user to a download site.

On the other hand, if the methods conform to each other (YES in S803), the process proceeds to S805. In S805, if there are a plurality of conforming dividing/combining methods and checksum calculation methods, the transmission control unit 112 selects a dividing/combining method and checksum calculation method to be used from them. The transmission control unit 112 can select optimal ones by, for example, determining a combination of the size of photo album data to be uploaded and a communication band. The transmission control unit 112 may acquire a preferred order of selecting a dividing/combining method and checksum calculation method from the management server 210 in S802 and select methods to be used based on the preferred order. Then, the transmission control unit 112 notifies the management server 210 of the dividing/combining method and checksum calculation method to be used to upload photo album data.

In the present embodiment, the PC 100 is notified of a dividing/combining method and checksum calculation method supported by the management server 210 and selects a dividing/combining method and checksum calculation method to be used by the PC 100. In another embodiment, the management server 210 may be notified of a dividing/combining method and checksum calculation method supported by the PC 100 and select a dividing/combining method and checksum calculation method to be used by the management server 210.

In S806, the management server 210 receives the dividing/combining method and checksum calculation method used by the PC 100.

In S600, the transmission control unit 112 uses the notified dividing/combining method and checksum calculation method to perform a divided upload of the photo album data to be uploaded. The management server 210 uses the dividing/combining method and checksum calculation method received in S806 to combine the received photo album data.

In S503, the application 110 notifies the management server 210 of the completion of the photo album data upload. After the notification is provided to the management server 210, the process of this flowchart is ended.

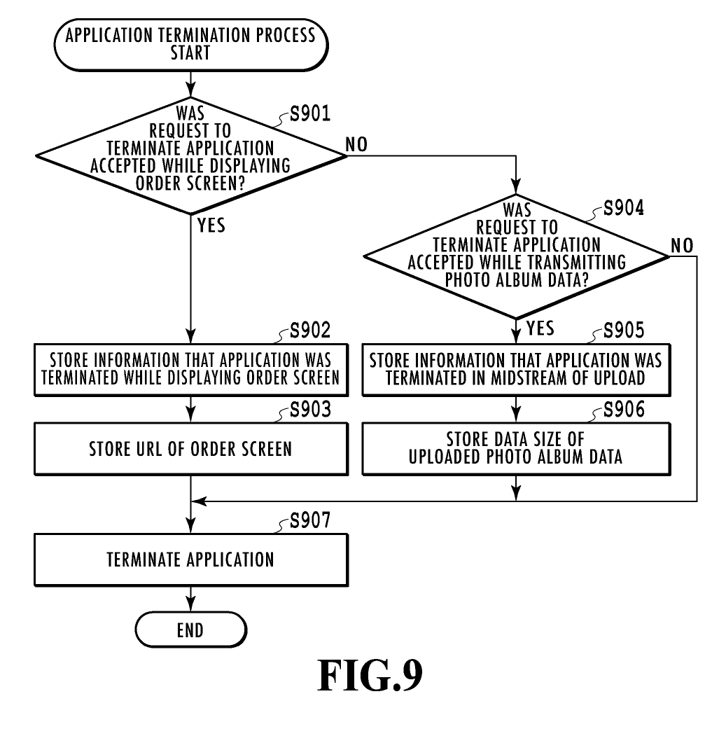

Next, a procedure at the termination of the application 110 will be described with reference to the flowchart of FIG. 9.

In S901, the application 110 determines whether a request to terminate the application 110 was accepted while displaying the order screen (FIG. 4D) of the shopping site 201. For example, the application 110 determines whether the “x” button in the display screen 400d was selected by a user. If the application 110 determines that the termination request was accepted (YES in S901), the process proceeds to S902. Incidentally, the display of the order screen is realized by the URL acquisition unit 115 requesting the web server 200 to issue a URL to display the order screen and the display control unit 114 allowing the web browser 120 to display the order screen based on the acquired URL.

In S902, the application 110 stores, in the HDD 104, information that the application 110 was terminated while displaying the order screen of the shopping site 201.

In S903, the application 110 stores the URL of the order screen of the shopping site 201 in the HDD 104. At this time, the application 110 stores not only the URL of the order screen but also information about a product added to a shopping cart in the display screen 400b (preview screen) in the HDD 104. After the process of S903, the process proceeds to S907.

On the other hand, if the application 110 determines that a request to terminate the application 110 was accepted while not displaying the order screen of the shopping site 201 (NO in S901), the process proceeds to a determination process of S904. In S904, the application 110 determines whether the request to terminate the application 110 was accepted while transmitting photo album data to the management server 210. For example, the application 110 determines whether the “x” button in the display screen 400c was selected by a user. If the termination request was accepted (YES in S904), the process proceeds to S905.

In S905, the application 110 stores, in the HDD 104, information that the application 110 was terminated while uploading photo album data.

In S906, the application 110 stores the data size of photo album data that has already been uploaded to the management server 210 in the HDD 104. After the process of S906, the process proceeds to S907.

On the other hand, if the request to terminate the application 110 was accepted while not uploading photo album data (NO in S904), the process proceeds to S907.

In S907, the application 110 terminates its operation. After the operation of the application 110 is terminated, the process of this flowchart is ended. If the request to terminate the application 110 was accepted in the midstream of a divided upload (FIG. 6 and FIG. 7), the application 110 also stores, in the HDD 104, information about which of divided pieces of photo album data could not be uploaded.

For example, it is assumed that the application 110 has been terminated by the process of FIG. 9 with some pieces of photo album data uploaded and the other pieces of the data not uploaded. In this case, if a retention period of the uploaded pieces of the photo album data has been elapsed at the start of the application 110, the server may delete the uploaded pieces of the data. Further, the application 110 may be terminated by the process of FIG. 9 while displaying the order screen. In this case, if a retention period of photo album data has been elapsed at the restart of the application, the server may delete the uploaded photo album data.

In view of the above, there is a method of restarting an application from an initial state uniformly regardless of the presence or absence of a retention period and requesting a user to create and upload photo album data again if the application was terminated in the midstream of a data upload or before order confirmation. In this case, however, a user should perform initial operation even if a retention period has not been elapsed at the restart of the application 110 and uploaded data can be used, and furthermore, it takes time to upload data.

Accordingly, in the present embodiment, at the start of the application 110, the process is resumed from a suitable step of the process such as an order step or upload step depending on whether a retention period of data in the server has been elapsed.

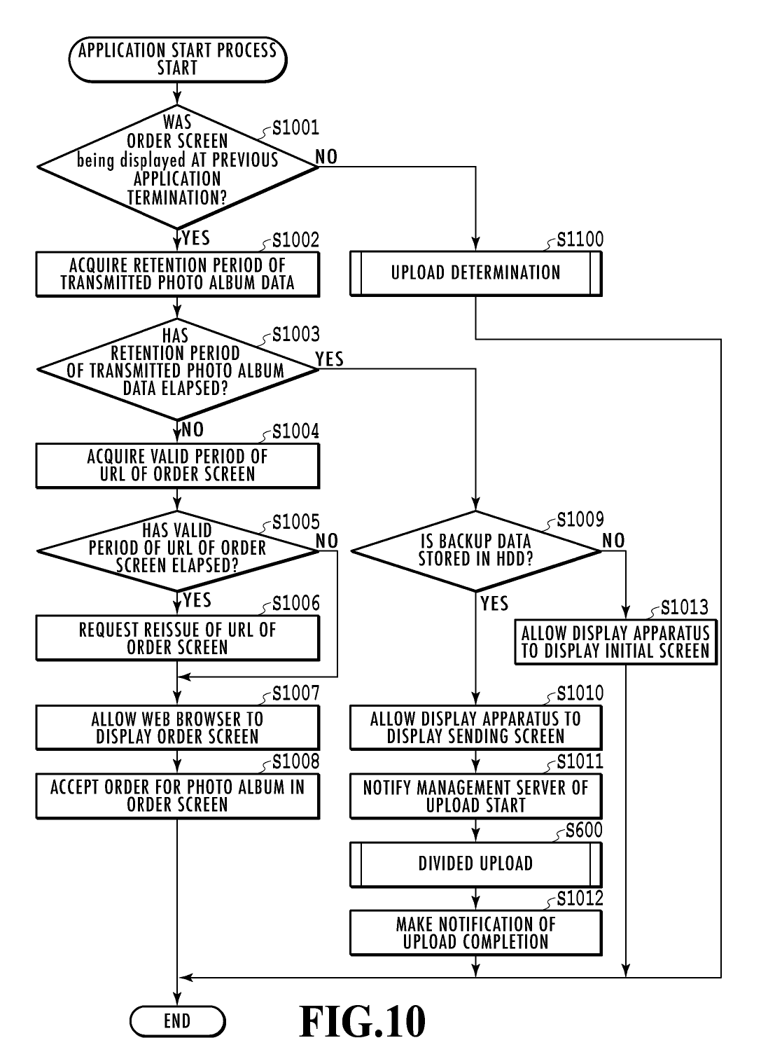

A procedure at the start of the application 110 will be described with reference to the flowchart of FIG. 10.

In S1001, the application 110 determines whether the order screen was being displayed at a previous application termination. More specifically, the application 110 determines whether the information to be stored in S902 is stored in the HDD 104. If the order screen was being displayed (YES in S1001), the process proceeds to S1002. At this time, the information is deleted from the HDD 104.

In S1002, the retention period acquisition unit 113 acquires a retention period of transmitted photo album data from the management server 210. The retention period in the present embodiment is a period during which the management server 210 retains photo album data uploaded from the PC 100 in a storage area of the management server 210. For example, seven days may be set as the retention period. The management server 210 notifies the PC 100 of the retention period managed by itself in response to an acquisition request from the PC 100. In this manner, a CPU (not shown) or the like of the management server 210, which makes a notification of the retention period managed by itself in response to an acquisition request from the PC 100, has the retention period notification function.

Incidentally, for example, if the retention period in the management server 210 is fixed, the PC 100 may acquire the retention period preset in the application 110 in S1002 without communicating with the management server 210. However, making a notification of a retention period from the management server 210 as described above makes it possible to dynamically change a retention period considered in the PC 100 in accordance with various changes in the management server 210 such as a change in the retention period in the management server 210.

In S1003, the application 110 determines whether the retention period of the transmitted photo album data has been elapsed. If the retention period continues (NO in S1003), the process proceeds to S1004.

In S1004, the application 110 acquires a valid period of the URL of the order screen from the web server 200. The valid period in the present embodiment is a period during which the application 110 can use the URL to access the web server 200 and display a given screen (order screen) on the web browser 120. In the technical field of web services, session management is generally carried out in the web server 200. In a period during which the web server 200 retains session information (generally a period of about 30 minutes), the application 110 can access the web server 200 using the same URL to call the same order screen. If the web server 200 abandons the session information, the application 110 cannot call the same order screen even by accessing the web server 200 using the same URL. That is, a period during which the session information is retained in the web server 200 can be regarded as the valid period in the present embodiment.

In S1005, the application 110 determines whether the valid period of the URL acquired in S1004 has been elapsed. If the valid period of the URL has been elapsed (YES in S1005), the process proceeds to S1006. If the valid period of the URL continues (NO in S1005), the process skips S1006 to proceed to S1007.

In S1006, the URL acquisition unit 115 requests the web server 200 to reissue a URL to access the order screen. The web server 200 reissues a URL to access the order screen in response to the reissue request from the PC 100 and notifies the PC 100 of the reissued URL. In this manner, the CPU (not shown) or the like of the web server 200, which makes a notification of a URL in response to a reissue request from the PC 100, has the URL notification function.

In the present embodiment, the printer server 220 can issue a print instruction to the printer 500 by using retained photo album data as long as a retention period continues. Accordingly, even if a valid period of a URL has been elapsed, the restarted application 110 can immediately access the order screen and accept an order for a photo album from a user once a new URL that enables access to the order screen is issued. That is, it is possible to save the trouble of reediting a photo album (FIG. 4B) and the time to reupload photo album data at the restart of the application 110.

In S1007, the display control unit 114 allows the web browser 120 to display the order screen by using the URL acquired in S1004 or the URL received in S1006. At this time, the application 110 reads the information about a product added to a shopping cart from the HDD 104. The state of the shopping cart at a previous application termination can be restored at the restart of the application 110 by reading the information about a product added to the shopping cart from the HDD 104.

In S1008, the application 110 accepts an order for a photo album in response to the press of the order button 491 in the order screen. After the order for the photo album is accepted, the process of this flowchart is ended.

If the retention period has been elapsed in S1003 (YES in S1003), the process proceeds to S1009. In S1009, the application 110 determines whether backup data is stored in the HDD 104. If the backup data is stored (YES in S1009), the process proceeds to S1010.

In S1010, the display control unit 114 allows the display apparatus 108 to display the sending screen (FIG. 4C) indicating that photo album data is being uploaded.

In S1011, the transmission control unit 112 notifies the management server 210 of the start of a photo album data upload.

In S600, the transmission control unit 112 performs a divided upload of photo album data. The divided upload in S600 is the same as that in FIG. 6 or FIG. 7.

In S1012, the transmission control unit 112 notifies the management server 210 of the completion of the photo album data upload. That is, if the backup data is stored in the HDD 104, the restarted application 110 displays the sending screen without reuploading the photo album data from the beginning. After the notification is provided to the management server 210, the process of this flowchart is ended.

On the other hand, if the application 110 determines that the backup data is not stored in the HDD 104 in S1009 (NO in S1009), the process proceeds to S1013. In S1013, the display control unit 114 allows the display apparatus 108 to display an initial screen displayed at the start of the application 110. That is, if the backup data is not stored, the application 110 is restarted from the initial state, not from the state of a previous termination. After the application 110 is restarted, the process of this flowchart is ended.

In S1001, if the order screen was not being displayed at the previous application termination (NO in S1001), the process proceeds to S1100.

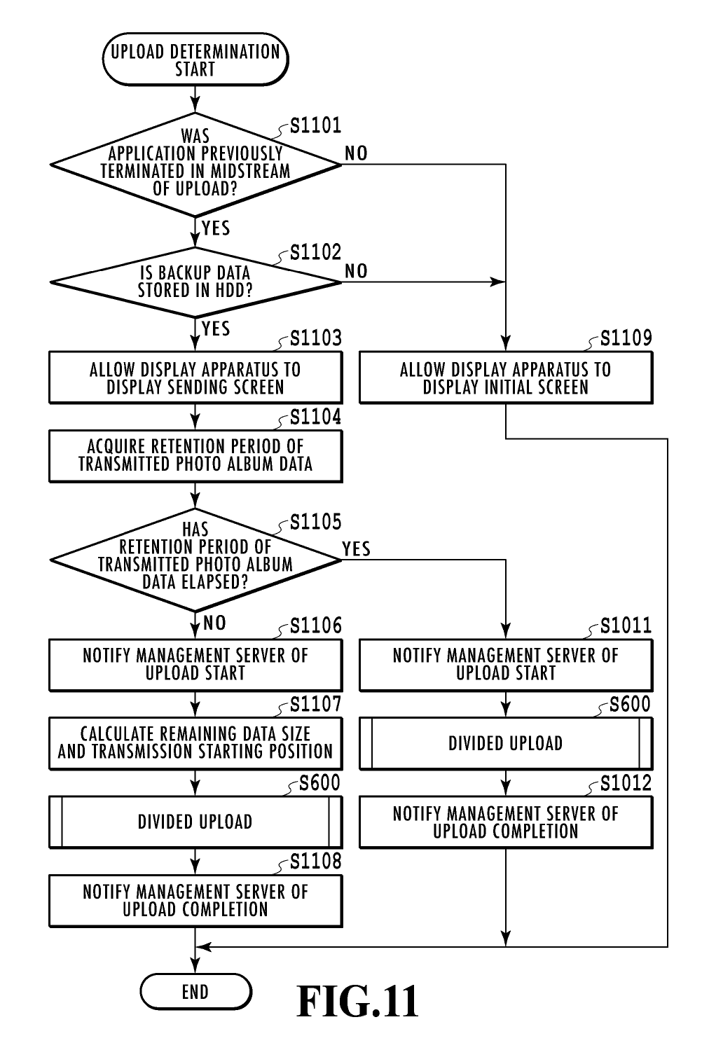

In S1100, the application 110 determines whether photo album data was being uploaded at the previous application termination. The procedure of a subroutine of S1100 will be described in detail with reference to FIG. 11. After the determination process of S1100, the process of this flowchart is ended.

FIG. 11 is a flowchart showing the details of an upload determination process to determine whether photo album data was being uploaded at a previous application termination in the present embodiment. The process of this flowchart corresponds to S1100 in FIG. 10.

In S1101, the application 110 determines whether photo album data was being uploaded at a previous application termination. More specifically, the application 110 determines whether the information to be stored in S905 is stored in the HDD 104. If the data was being uploaded (YES in S1101), the process proceeds to S1102. At this time, the information is deleted from the HDD 104.

In S1102, the application 110 determines whether backup data is stored in the HDD 104. If the backup data is stored (YES in S1102), the process proceeds to S1103.

In S1103, the display control unit 114 allows the display apparatus 108 to display the sending screen (FIG. 4C) indicating that photo album data is being uploaded.

In S1104, the retention period acquisition unit 113 acquires a retention period of transmitted photo album data from the management server 210.

In S1105, the application 110 determines whether the retention period of the transmitted photo album data has been elapsed. If the retention period continues (NO in S1105), the process proceeds to S1106. If the retention period has been elapsed (YES in S1105), the process proceeds to S1011.

In S1106, the transmission control unit 112 notifies the management server 210 of the start of a photo album data upload.

In S1107, the application 110 uses the size of the backup data stored in S501 and the size of photo album data uploaded and stored in S906 to calculate the size of the rest of the photo album data not transmitted in the previous upload. Then, the application 110 specifies a transmission starting position of backup data to be transmitted in the current upload.

In S600, the transmission control unit 112 executes a divided upload of the backup data from the transmission starting position specified in S1107. That is, the transmission control unit 112 transmits the backup data to the management server such that the backup data is continued from photo album data that was transmitted to the management server 210 until the previous upload was stopped. The divided upload in S600 is the same as that in FIG. 6 or FIG. 7.

In S1108, the transmission control unit 112 notifies the management server 210 of the completion of the photo album data upload. That is, if the retention period continues, the application 110 is restarted from the uploading state at the previous termination of the application 110 and allows the display apparatus 108 to display the sending screen. After the notification is provided to the management server 210, the process of this flowchart is ended.

On the other hand, if the retention period of the photo album data has been elapsed in S1105 (YES in S1105), the application 110 executes the processes of S1011 and S1012 to retransmit the photo album data to the management server 210. The processes of S1011 and S1012 are the same as those of S1011 and S1012 in the flowchart of FIG. 10. That is, even if photo album data was being uploaded at the previous application termination, the photo album data is transmitted to the management server 210 from the beginning on the condition that the retention period has been elapsed.

In S1101, if photo album data was not being uploaded at the previous application termination (NO in S1101), the process proceeds to S1109. In S1109, the display control unit 114 allows the display apparatus 108 to display the initial screen displayed at the start of the application 110. That is, if data was not being uploaded at the previous application termination or if the backup data is not stored, the application 110 is restarted from the initial state, not from the state of the previous termination. After the initial screen is displayed on the display apparatus 108 of the PC 100, the process of this flowchart is ended.

As described above, the information processing apparatus of the present embodiment determines a process at the restart of an application in consideration of a retention period of data uploaded to a server in an electronic commerce system accompanied by data uploads. It is therefore possible to prevent the application from being restarted from the initial state, thereby saving the trouble of reediting a photo album and the time to reupload photo album data and increasing user convenience.

### Embodiment 2

The application 110 of Embodiment 1 is restarted from the state of an application termination on the condition that a retention period continues if data was being uploaded or the order screen was being displayed at the previous application termination. However, if a period from the termination to restart of the application 110 is long, a user may forget the existence of a photo album that did not reach order confirmation. In this case, it is preferable in view of user convenience that the application 110 is restarted from the initial state rather than from the state of the previous termination. Accordingly, in the present embodiment, a time from the termination to restart of the application 110 is measured. If the measured time is equal to or greater than a predetermined threshold, the application 110 is restarted from the initial state. The features of the present embodiment will be described below.

The hardware configuration of the PC 100 (information processing apparatus) (FIG. 1 and FIG. 2), the functional configuration of the application 110 (FIG. 3), and the display screens on the display apparatus 108 (FIG. 4A to FIG. 4D) in the present embodiment are the same as those in Embodiment 1. Differences in the procedure executed by the application 110 between the present embodiment and Embodiment 1 will be described below.

The first difference is that in the process at the termination of the application 110 (FIG. 9), time information at the termination of the application 110 is stored in the HDD 104 immediately before terminating the application (S907). The second difference is that in the start process of the application 110 (FIG. 10), a time elapsed from the previous termination of the application 110 is calculated immediately before the determination process of S1001. More specifically, the application 110 acquires the time information at the start from the OS and calculates the time elapsed from the previous termination of the application 110 based on the acquired time information and the time information stored in the HDD 104. The third difference is that the application 110 is started from the initial state if the calculated elapsed time is equal to or greater than a predetermined threshold. At this time, the predetermined threshold may be always a fixed value or may be a value variable according to the operating environments of the PC 100 and management server 210.

As described above, the information processing apparatus of the present embodiment can start an application in consideration of a time elapsed from the previous termination of the application in addition to the advantageous result of Embodiment 1.

### Embodiment 3

The application 110 of Embodiment 1 is restarted from the state of an application termination on the condition that a retention period continues if data was being uploaded or the order screen was being displayed at the previous application termination. However, if a user wants to order a photo album different from a photo album that the user previously tried to order, it is preferable in view of user convenience that the application 110 is restarted from the initial state rather than from the state of the previous termination. Accordingly, in the present embodiment, an instruction indicating whether to restart the application 110 from the state of the previous application termination or from the initial state is accepted from a user and the application 110 is restarted in accordance with the instruction. The features of the present embodiment will be described below.

The hardware configuration of the PC 100 (information processing apparatus) (FIG. 1 and FIG. 2), the functional configuration of the application 110 (FIG. 3), and the display screens on the display apparatus 108 (FIG. 4A to FIG. 4D) in the present embodiment are the same as those in Embodiment 1. Differences in the procedure executed by the application 110 between the present embodiment and Embodiment 1 will be described below.

The first difference is that in the start process (FIG. 10) of the application 110, the application 110 allows the display apparatus 108 to display a UI to accept an instruction from a user immediately before S1007. The application 110 accepts, via the UI, an instruction indicating whether to restart the application 110 from the state where the order screen is being displayed or from the initial state. The second difference is that in the start process (FIG. 10) of the application 110, the application 110 allows the display apparatus 108 to display a UI to accept an instruction from a user immediately before S1009. The application 110 accepts, via the UI, an instruction indicating whether to restart the application 110 from the state where photo album data is being uploaded or from the initial state. The third difference is that in the start process (FIG. 11) of the application 110, the application 110 allows the display apparatus 108 to display a UI to accept an instruction from a user immediately before S1103. The application accepts, via the UI, an instruction indicating whether to restart the application 110 from the state where photo album data is being uploaded or from the initial state. The fourth difference is that if an instruction to restart the application from the initial state is accepted, the application 110 is restarted from the initial state and allows the display apparatus 108 to display the initial screen.

As described above, the information processing apparatus of the present embodiment can start an application in consideration of user's intention regarding whether to resume the application from the state of the previous termination in addition to the advantageous result of Embodiment 1.

### Embodiment 4

The application 110 of Embodiment 1 is restarted from the state of an application termination on the condition that a retention period continues if data was being uploaded or the order screen was being displayed at the previous application termination. However, photo album data includes a large amount of image data and therefore it takes time to upload the photo album data. If a user cannot wait the completion of the upload, it is not preferable in view of user convenience that the restarted application 110 immediately resumes uploading the photo album data. Accordingly, in the present embodiment, a user is allowed to select whether to start upload immediately even if it is possible to restart the application from the state where photo album data is being uploaded. The features of the present embodiment will be described below.

The hardware configuration of the PC 100 (information processing apparatus) (FIG. 1 and FIG. 2), the functional configuration of the application 110 (FIG. 3), and the display screen on the display apparatus 108 (FIG. 4A) in the present embodiment are the same as those in Embodiment 1. Differences in the procedure executed by the application 110 between the present embodiment and Embodiment 1 will be described below.

The first difference is that in the start process (FIG. 10) of the application 110, the application 110 allows the display apparatus 108 to display a UI to accept an instruction from a user immediately before S1009. The application 110 accepts, via the UI, an instruction indicating whether to start an upload immediately or terminate the application without starting an upload. The second difference is that in the start process (FIG. 11) of the application 110, the application 110 allows the display apparatus 108 to display a UI to accept an instruction from a user immediately before S1103. The application 110 accepts, via the UI, an instruction indicating whether to start an upload immediately or terminate the application without starting an upload. The third difference is that if an instruction to terminate the application without starting an upload is selected, the application 110 terminates its operation.

As described above, the information processing apparatus of the present embodiment can start an application in consideration of user's intention regarding whether to immediately resume an upload in addition to the advantageous result of Embodiment 1.

Embodiments are not limited to the embodiments described above, and can be variously modified or changed within the scope of the gist of the present invention. For example, each of the web server 200, the management server 210, and the printer server 220 is independent hardware in the present embodiment, but one server hardware may provide the functions of the web server, management server, and print server.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The information processing apparatus, server, method of controlling the information processing apparatus, and storage medium of the present invention produces an advantageous result of increasing user convenience in an electronic commerce system accompanied by data uploads.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-015517, filed Jan. 31, 2017, which is hereby incorporated by reference wherein in its entirety.

What is claimed is:

1. An information processing method comprising:
a transmission control step of performing transmission control of data to a server;
a storage control step of storing backup data for data to be transmitted to the server; and
an acquisition step of acquiring a retention period of data transmitted to the server,
wherein in the transmission control step, in a case where the transmission control was stopped and is started again and the acquired retention period continues, the stored backup data is transmitted so as to be continued from data that was transmitted to the server until the transmission control was stopped.

2. The information processing method according to claim 1, wherein in the transmission control step, in a case where the transmission control was stopped and is started again and the acquired retention period has been elapsed, the stored backup data is retransmitted from the beginning.

3. The information processing method according to claim 1, wherein in the transmission control step, in a case where the transmission control was stopped and is started again and a time from the stop of the transmission control to the start of the transmission control is equal to or greater than a predetermined threshold, the stored backup data is retransmitted from the beginning irrespective of whether the acquired retention period continues.

4. The information processing method according to claim 1, wherein in the transmission control step, in a case where the transmission control was stopped and is started again and an instruction to retransmit the data to be transmitted from the beginning is accepted from a user, the stored backup data is retransmitted from the beginning irrespective of whether the acquired retention period continues.

5. The information processing method according to claim 1, further comprising a display control step of performing display control of a screen of a display unit,
wherein in the display control step, in a case where the transmission control was stopped and is started again and the acquired retention period continues, a sending screen indicating that the data is being transmitted to the server, which was being displayed until the transmission control was stopped, is displayed again on the display unit.

6. The information processing method according to claim 1, wherein in the transmission control step, the data to be transmitted is divided into pieces and the divided pieces of the data are transmitted to the server.

7. The information processing method according to claim 6, wherein in the transmission control step, in a case where a checksum calculated from a divided piece of the data before being transmitted to the server is different from a checksum calculated from the divided piece of the data after being transmitted to the server, the divided piece of the data is retransmitted to the server.

8. The information processing method according to claim 1, wherein the data is photo album data used to create a photo album, the photo album data comprising at least image data indicating images to be included in the photo album.

9. An information processing method comprising:
a transmission control step of performing transmission control of data to a server;
an acquisition step of acquiring a retention period of data transmitted to the server; and
a display control step of performing, based on a URL acquired from the server, display control of an order screen capable of accepting an order for a product created using the data,
wherein in the display control step, in a case where the display control was stopped and is started again and the acquired retention period continues, the order screen, which was being displayed until the display control was stopped, is displayed again on a display unit.

10. The information processing method according to claim 9, wherein in the display control step, in a case where the display control was stopped and is started again and the acquired retention period has been elapsed, an initial screen indicating that the steps of the information processing method are started from the first step is displayed on the display unit.

11. The information processing method according to claim 9, wherein in a case where the display control was stopped and is started again and the acquired retention period continues,
in the display control step, in a case where a valid period of the URL has been elapsed, the server is requested to issue a new URL different from the URL and the order screen, which was being displayed until the display control was stopped, is displayed again on a display unit based on the issued new URL.

12. The information processing method according to claim 9, wherein the data is photo album data used to create a photo album, the photo album data comprising at least image data indicating images to be included in the photo album.

13. A server connected to an information processing apparatus via a network so as to communicate with the information processing apparatus, the server comprising:
a storage unit configured to store data in a storage area of the server for a given retention period, the data being used to create a product received from the information processing apparatus; and
a retention period notification unit configured to notify the information processing apparatus of the retention period in response to an acquisition request from the information processing apparatus.

14. The server according to claim 13, further comprising:
a management unit configured to manage a valid period of a URL to access a site capable of accepting an order for the product;
an issuing unit configured to issue a new URL, which is different from the URL, to access the site capable of accepting an order for the product in response to a request from the information processing apparatus in a case where the valid period of the URL has been elapsed and the retention period continues; and
a URL notification unit configured to notify the information processing apparatus of the issued URL.
